(19) United States
(12) Patent Application Publication
(10) Pub. No.: US 2025/0029797 A1
(43) Pub. Date: Jan. 23, 2025

(54) Button Assembly

(71) Applicant: Illinois Tool Works Inc., Glenview, IL (US)

(72) Inventors: Wenquan SHA, Shanghai (CN); Changsuo LI, Shanghai (CN); Hongpeng ZHONG, Shanghai (CN); Kangxi NING, Shanghai (CN)

(21) Appl. No.: 18/767,596

(22) Filed: Jul. 9, 2024

(30) Foreign Application Priority Data
Jul. 20, 2023 (CN) 202310894646.8

(51) Int. Cl. H01H 13/06

(52) U.S. Cl. CPC H01H 13/06

(57) ABSTRACT

The present disclosure provides a button assembly, comprising a pressing portion (101), a housing (102) and a connecting portion (103). The housing (102) comprises a tubular side wall (308), the side wall (308) having a first end (381) and a second end (382), and the first end (381) having a first opening (315). The connecting portion (103) is arranged between the pressing portion (101) and the housing (102), and the connecting portion (103) is connected to the pressing portion (101) and the first end (381) of the side wall (308) in a sealed manner, such that the pressing portion (101) and the connecting portion (103) cover the first opening (315). The connecting portion (103) is made of an elastic material, such that the pressing portion (101) is movable relative to the housing (102). The button assembly of the present disclosure has a good waterproof performance.

### RELATED APPLICATION

The present application claims the benefit of Chinese Patent Application No. 202310894646.8, filed Jul. 20, 2023, each titled “Button Assembly,” the contents of which are hereby incorporated by reference.

### TECHNICAL FIELD

The present disclosure relates to a button assembly, and in particular to a waterproof button assembly.

### BACKGROUND

A button assembly is used for achieving corresponding functional control by means of a pressing operation from an operator. The button assembly comprises a supporting structure and a circuit device, and the supporting structure is connected at a corresponding installation position. The supporting structure comprises a pressing portion, and the operator can trigger and control the circuit device by operating the pressing portion to achieve a corresponding function.

### SUMMARY

The present disclosure relates generally to a button assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples t hereof, as illustrated in the accompanying figures; where like or similar reference numbers refer t o like or similar structures. The figures are not necessarily to scale, emphasis instead being place d upon illustrating the principles of the devices, systems, and methods described herein.

FIG. 1A is a perspective view of a button assembly according to the present disclosure.

FIG. 1B is an exploded view of the button assembly in FIG. 1A.

FIG. 2 is an exploded view of a body of the button assembly in FIG. 1B.

FIG. 3A is a perspective view of a housing in FIG. 2.

FIG. 3B is a perspective view of the housing in FIG. 3A from another perspective.

FIG. 4A is a perspective view of a pressing portion in FIG. 2.

FIG. 4B is a perspective view of the pressing portion in FIG. 4A from another perspective.

FIG. 5A is a perspective view of a connecting portion in FIG. 2.

FIG. 5B is a cross-sectional view of the connecting portion in FIG. 5A.

FIG. 6 is a perspective view of a circuit device in FIG. 1B.

FIG. 7 is a cross-sectional view of the button assembly in FIG. 1A.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a button assembly, which comprises a pressing portion, a housing and a connecting portion; wherein the housing comprises a tubular side wall, the side wall having a first end and a second end, and the first end having a first opening; the connecting portion is arranged between the pressing portion and the housing, and the connecting portion is connected to the pressing portion and the first end of the side wall in a sealed manner, such that the pressing portion and the connecting portion cover the first opening; and the connecting portion is made of an elastic material, such that the pressing portion is movable relative to the housing.

According to the button assembly as described above, the pressing portion, the connecting portion, and the housing are of an integrated structure.

According to the button assembly as described above, the button assembly further comprises a circuit device, and the circuit device is located inside the housing.

According to the button assembly as described above, an inner side of the housing comprises a limiting surface and a snap, the limiting surface is arranged facing the second end, the snap is located at a side of the limiting surface facing the second end, and the circuit device is capable of being clamped between the limiting surface and the snap.

According to the button assembly as described above, the limiting surface continuously extends in a circumferential direction.

According to the button assembly as described above, when the circuit device is installed in the housing, the circuit device is sealed within the housing by means of a potting and sealing process.

According to the button assembly as described above, both the pressing portion and the first end of the housing have an anti-off structure, and the anti-off structure comprises protrusions, grooves and/or stepped portions.

According to the button assembly as described above, the connecting portion comprises an annular rib, and the rib protrudes from an outer surface of the connecting portion in a direction away from the second end of the side wall.

According to the button assembly as described above, the connecting portion is connected to the pressing portion and the housing by means of a two-color injection molding process.

According to the button assembly as described above, an inner wall of the housing comprises a guide rib extending in a direction from the second end to the first end of the side wall, the circuit device comprises a guide recess, and the guide recess is capable of cooperating with the guide rib to guide an installation direction of the circuit device.

According to the button assembly as described above, the second end has a second opening, when the circuit device is connected to the housing, the circuit device is installed into the housing from the second opening, causing the circuit device to be clamped between the limiting surface and the snap, and then the circuit device is potted through the second opening, such that the circuit device is connected to the housing in a sealed manner.

According to the button assembly as described above, the connecting portion comprises a corrugated portion.

In the present disclosure, the button assembly has a housing, a connecting portion and a pressing portion, wherein the connecting portion is made of the elastic material, and the connecting portion is connected to the housing and the pressing portion in a sealed manner, so that water can be prevented from entering the interior of the button assembly from the pressing portion, and thus the button assembly has a good waterproof function. The circuit device in the present disclosure is directly installed into the housing, so that the circuit device is connected to the housing without additionally providing a fastening structure. The button assembly of the present disclosure has fewer parts, thus decreasing installation steps of the button assembly.

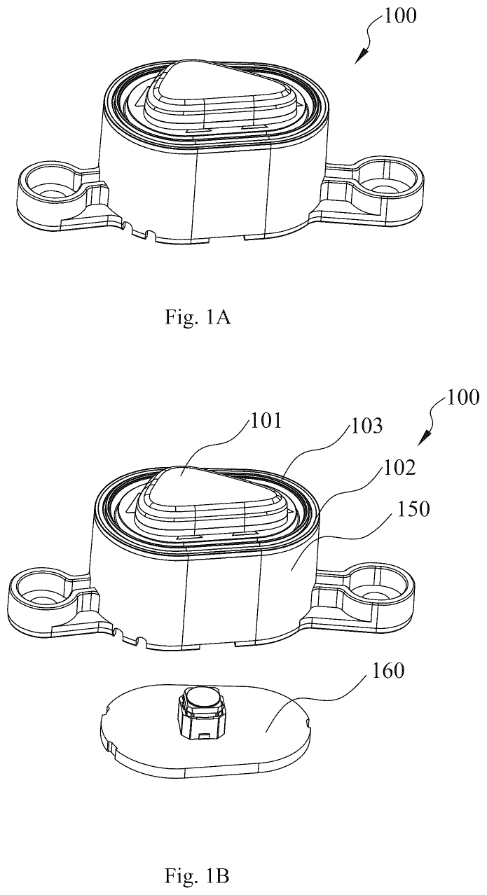

FIG. 1A is a perspective view of a button assembly according to the present disclosure, and FIG. 1B is an exploded view of the button assembly in FIG. 1A. As shown in FIGS. 1A and 1B, the button assembly 100 comprises a body 150 and a circuit device 160. The circuit device 160 is located inside the body 150. The body 150 comprises a pressing portion 101, a housing 102 and a connecting portion 103. The pressing portion 101 is connected to the housing 102 by means of the connecting portion 103. The pressing portion 101 is configured to be operated by an operator to trigger a corresponding part of the circuit device 160.

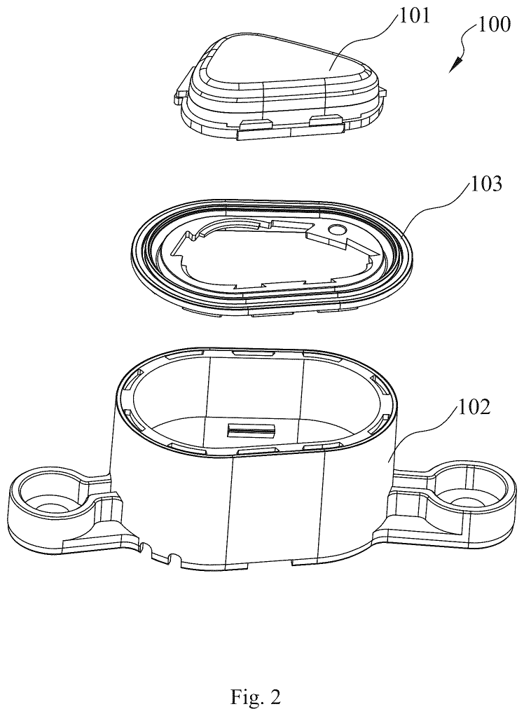

FIG. 2 is an exploded view of the body of the button assembly in FIG. 1B. As shown in FIG. 2, the pressing portion 101 is connected to one end of the body 150 by means of the connecting portion 103. The pressing portion 101 and the housing 102 are made of a material having a certain hardness. The connecting portion 103 is made of an elastic material, such that the pressing portion 101 is movable and resettable relative to the housing 102. The connecting portion 103 is connected to the pressing portion 101 and the housing 102 in a sealed manner. In an application of the present disclosure, the pressing portion 101, the connecting portion 103 and the housing 102 are made by means of a two-color injection molding process, and form an integrated structure. That is to say, the body 150 encloses a cavity whose one end is opening and remaining part is closed.

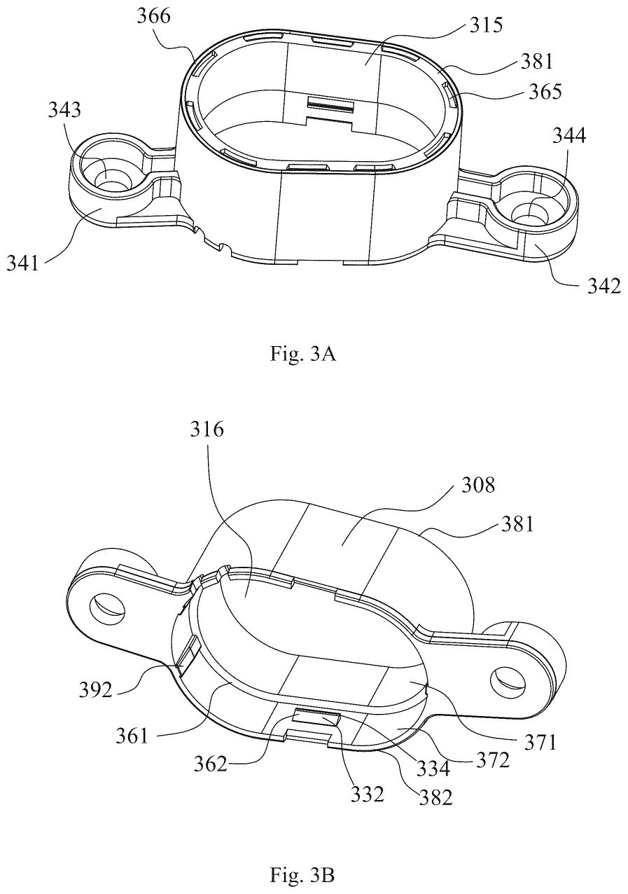

FIG. 3A is a perspective view of the housing in FIG. 2, and FIG. 3B is a perspective view of the housing in FIG. 3A from another perspective. As shown in FIGS. 3A and 3B, the housing 102 comprises a side wall 308 and a pair of protruding portions 341 and 342. The side wall 308 is substantially of a hollow tubular structure, and the side wall 308 extends in an axial direction and has a first opening 315 at a first end 381 and a second opening 316 at a second end 382. The pair of protruding portions 341 and 342 extend from an outer side of the second end 382 in a direction away from each other. Connecting holes 343 and 344 are formed in the protruding portions 341 and 342, and the connecting holes 343 and 344 are configured to fit with installation structures, such as screws, to secure the housing 102 to an installation part.

The first end 381 of the side wall 308 has a plurality of grooves 365, and the plurality of grooves 365 are formed by being recessed from an end surface of the first end 381 toward the second end 382. The plurality of grooves 365 are uniformly distributed in a circumferential direction of the first end 381. When the first end 381 is connected to the connecting portion 103, the material of the connecting portion 103 can be embedded into the plurality of grooves 365, so that the connecting firmness between the connecting portion 103 and the first end 381 is strengthened, thereby preventing the connecting portion 103 from falling off from the first end 381. The first end 381 further comprises an annular recess 366, and the annular recess 366 is recessed inwardly from a surface of the first end 381. The annular recess 366 is located outside the plurality of grooves 365. When the first end 381 is connected to the connecting portion 103, the material of the connecting portion 103 can be embedded into the annular recess 366, thus further strengthening the connecting firmness between the connecting portion 103 and the first end 381. That is to say, the plurality of grooves 365 and the annular recess 366 form an anti-off structure.

An inner side of the side wall 308 has a stepped surface 361 and a snap 362. The stepped surface 361 is arranged facing the second end 382. The side wall 308 comprises a first segment 371 and a second segment 372, the first segment 371 is close to the first end 381, the second segment 372 is close to the second end 382, and the inner diameter of the first segment 371 is less than the inner diameter of the second segment 372, such that the stepped surface 361 is formed at a joint between the first segment 371 and the second segment 372. The stepped surface 361 is annular and extends continuously in the circumferential direction. The stepped surface 361 can limit the continuous movement of the circuit device 160, which is installed into the housing 102 through the second opening 316, toward the first end 381. The snap 362 is arranged on a side of the stepped surface 361 close to the second end 382. The snap 362 is a protrusion which protrudes inwardly from an inner surface of the second segment 372. The snap 362 comprises an inclined slope 332. In a direction from the second end 382 to the first end 381, the slope 332 extends obliquely toward the interior of the housing 102, and the slope 332 is configured to guide the circuit device 160 to move toward the stepped surface 361. The snap 362 further comprises a joint surface 334 arranged facing the stepped surface 361. There is a spacing between the joint surface 334 and the stepped surface 361, and the spacing is substantially equal to the thickness at an edge of the circuit device 160, so that the snap 362 can cooperate with the stepped surface 361 to clamp the circuit device 160 between the snap 362 and the stepped surface 361. In the present disclosure, a plurality of snaps 362 may be provided and are distributed uniformly in the circumferential direction.

An inner side of the second segment 372 further comprises a guide rib 392, and the guide rib 392 extends in a direction from the second end 382 to the first end 381. The guide rib 392 is configured to guide an installation direction of the circuit device 160.

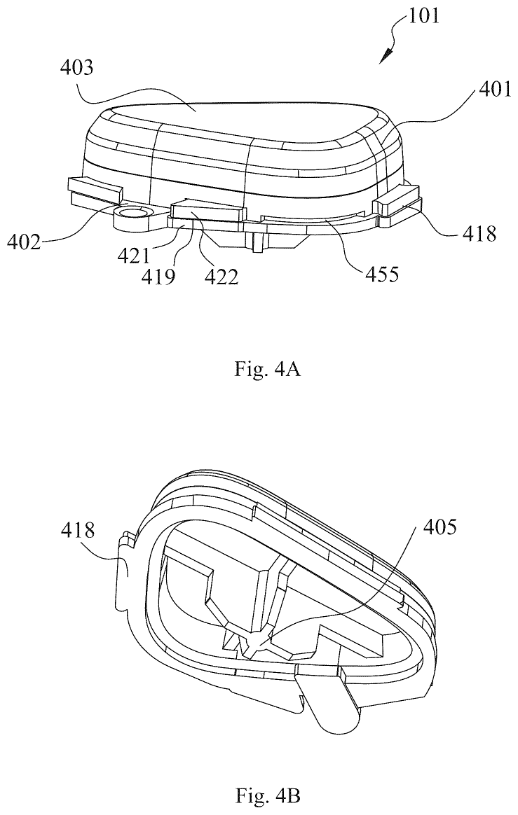

FIG. 4A is a perspective view of the pressing portion shown in FIG. 2, and FIG. 4B is a perspective view of the pressing portion in FIG. 4A from another perspective. As shown in FIGS. 4A and 4B, the pressing portion 101 comprises a central portion 401 and a flange portion 402. The flange portion 402 is formed by extending outwardly from an outer side of the central portion 401. A first side of the pressing portion 101 comprises a flat pressing surface 403, and the pressing surface 403 is arranged facing the operator to be pressed by the operator. A second side of the pressing portion 101 comprises a trigger protrusion 405, and the trigger protrusion 405 is arranged in a protruding manner. The trigger protrusion 405 may be in contact with the circuit device 160 to trigger a corresponding circuit.

The pressing portion 101 comprises a plurality of protrusions 418 which protrude outwardly from the central portion 401. The protrusion 418 is in a trapezoidal shape that gradually becomes wide from the inside to the outside. When the pressing portion 101 is connected to the connecting portion 103, the protrusion 418 can be embedded into the connecting portion 103, so that the connection strength between the connecting portion 103 and the pressing portion 101 is enhanced, thereby preventing the connecting portion 103 from falling off from the pressing portion 101 in an extending direction of the pressing surface 403. The flange portion 402 of the pressing portion 101 further comprises a plurality of stepped portions 419, the stepped portion 419 comprises a first step 421 and a second step 422, and the first step 421 extends beyond the second step 422 in a direction away from the central portion 401, such that the first step 421 and the second step 422 are arranged in a staggered manner, and the first step 421 and the second step 422 jointly form the stepped portion 419. The stepped portion 419 may be arranged at the protrusion 418, that is to say, one or more of the plurality of protrusions 418 comprise a first step and a second step which are arranged in a staggered manner. When the pressing portion 101 is connected to the connecting portion 103, the stepped portion 419 enhances the connection strength between the connecting portion 103 and the pressing portion 101, and prevents the connecting portion 103 from falling off from the pressing portion 101 in an extending direction perpendicular to the pressing surface 403, namely, in a movement direction of the pressing portion 101. The pressing portion 101 further comprises a plurality of grooves 465 recessed inwardly from an outer side surface surrounding the pressing portion 101, and the grooves 465 extend substantially in a direction parallel to the pressing surface 403. The grooves 465 are located at the central portion 401 or the flange portion 402. When the pressing portion 101 is connected to the connecting portion 103, the material of the connecting portion 103 can enter the grooves 465, thus enhancing the connection strength between the connecting portion 103 and the pressing portion 101. In the extending direction perpendicular to the pressing surface 403, namely, in the movement direction of the pressing portion 101, the grooves 465 are configured to prevent the connecting portion 103 from falling off from the pressing portion 101. In the pressing portion 101, the protrusions 418, the stepped portions 419, and the grooves 465 form an anti-off structure.

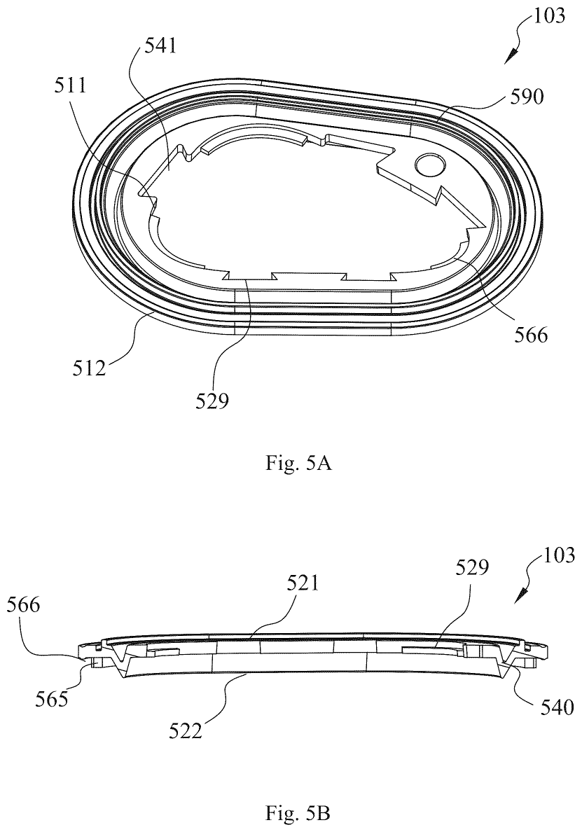

FIG. 5A is a perspective view of the connecting portion in FIG. 2, and FIG. 5B is a cross-sectional view of the connecting portion in FIG. 5A. As shown in FIGS. 5A and 5B, the connecting portion 103 is substantially an annular ring. An inner side 511 of the connecting portion 103 is connected to the pressing portion 101, and an outer side 512 thereof is connected to the housing 102. The inner side 511 of the connecting portion 103 is formed with recesses 541 which fit with the protrusions 418 of the pressing portion 101, and fitting portions 529 which fit with the stepped portions 419. The outer side 512 of the connecting portion 103 is formed with protrusions 565 which fit with the grooves 365 of the housing 102, protrusions 566 which fit with the grooves 465, and an annular protrusion 566 which fits with the annular recess 366 of the housing 102. The connecting portion 103 is made of the elastic material, and is connected to the pressing portion 101 and the housing 102 by means of the two-color injection molding process, so that the inner side 511 and the outer side 512 of the connecting portion 103 match corresponding parts of the pressing portion 101 and the housing 102 in shape.

The connecting portion 103 further comprises a corrugated portion 540. In an aspect of the present disclosure, the corrugated portion 540 is substantially of a V-shaped structure which protrudes from an upper surface 521 to a lower surface 522 of the connecting portion 103. In another aspect of the present disclosure, the corrugated portion 540 may comprise a plurality of continuous V-shaped structures. The corrugated portion 540 can increase the elasticity of the connecting portion 103, so that a pressing operation on the pressing portion 101 is more effort-saving.

The connecting portion 103 further comprises an annular rib 590, and the annular rib 590 protrudes upwardly from the upper surface 521 of the connecting portion 103. The annular rib 590 is configured to cooperate with an installation part to form a seal.

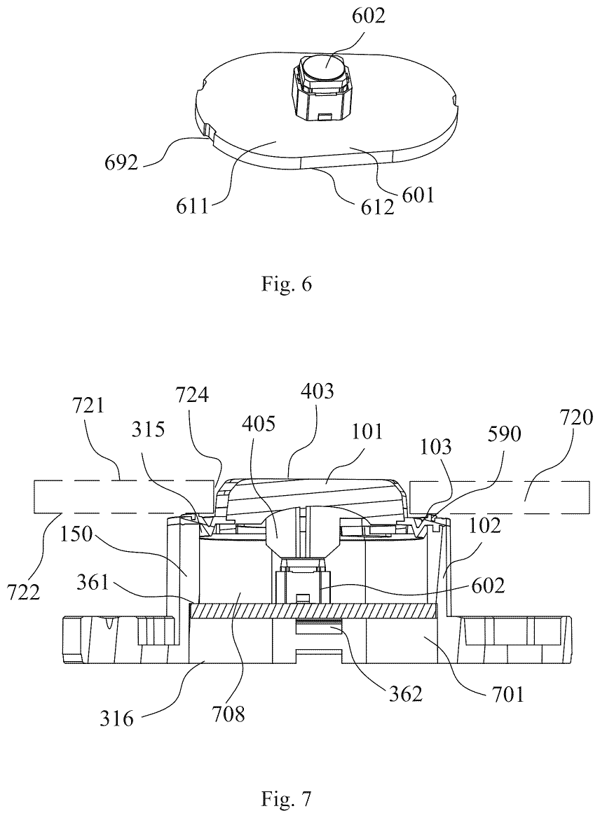

FIG. 6 is a perspective view of the circuit device in FIG. 1B. As shown in FIG. 6, the circuit device 160 comprises a flat plate portion 601 and a trigger portion 602. The flat plate portion 601 is substantially in the shape of a flat plate, and has an upper surface 611 and a lower surface 612. The trigger portion 602 is connected to the upper surface 611 of the flat plate portion 601. A guide recess 692 is provided on one side of the flat plate portion 601, and the guide recess 692 cooperates with the guide rib 392 of the housing 102 to indicate the installation direction of the circuit device 160 and prevent the circuit device 160 from being installed reversely.

The trigger portion 602 protrudes out from the flat plate portion 601, and the trigger portion 602 can cooperate with the trigger protrusion 405 of the pressing portion 101 to trigger the circuit.

FIG. 7 is a cross-sectional view of the button assembly in FIG. 1A. As shown in FIG. 7, the pressing portion 101 is connected to the first end 381 of the side wall 308 of the housing 102 by means of the connecting portion 103, so as to cover the first opening 315, the first end 381 of the side wall 308 is closed, and the body 150 encloses a cavity 701 which has one closed end and the second opening 316 at the other end.

When the circuit device 160 is installed, the trigger portion 602 faces the trigger protrusion 405 of the pressing portion 101, the guide recess 692 is aligned with the guide rib 392, and then the circuit device 160 is installed into the housing 102 through the second opening 316. The circuit device 160 continues to be pushed toward the pressing portion 101, and the flat plate portion 601 of the circuit device 160 goes over the snap 362 until the flat plate portion 601 comes into contact with the stepped surface 361, such that the circuit device 160 cannot continue to move toward the pressing portion 101. Meanwhile, the circuit device 160 is blocked by the snap 362 and cannot move in a direction away from the pressing portion 101, and the circuit device 160 is clamped between the stepped surface 361 and the snap 362. In this case, the circuit device 160 reaches a pre-installation position. At the pre-installation position of the circuit device, the top of the trigger portion 602 has a small spacing from the trigger protrusion 405 of the pressing portion 101 or contacts the trigger protrusion 405. Later, the circuit device 160 is potted through the second opening 316 by using a potting process, and a gap between the circuit device 160 and an inner wall of the housing 102 can be filled with an adhesive, so that a seal is formed between the circuit device 160 and the housing 102. After a potting operation is completed, the trigger portion 602 is sealed in a closed cavity 708 enclosed by the flat plate portion 601, the pressing portion 101, the connecting portion 103 and the housing 102. External water cannot enter the closed cavity 708, which avoids interference with the performance of the circuit device 160. The button assembly 100 has a good waterproof function.

In the present disclosure, when the potting operation is performed, the flowing adhesive is poured onto the lower surface 612 of the flat plate portion 601 of the circuit device 160, and the adhesive flows into the gap between the flat plate portion 601 and the housing 102 and flows toward the stepped surface 361. Since the stepped surface 361 extends continuously in the circumferential direction, the stepped surface 361 can guide the adhesive to flow uniformly, such that the adhesive is uniformly distributed in the circumferential direction. After standing for a certain time, the adhesive turns into a solid state, so that the circuit device 160 is connected to the housing in a sealed manner.

As shown in FIG. 7, the button assembly 100 is installed on an installation panel 720, and the installation panel 720 has a first side 721 facing a user and a second side 722 facing an interior space of a vehicle. The installation panel 720 has an installation hole 724 which runs through the first side 721 and the second side 722.

The pressing surface 403 of the central portion 401 of the pressing portion 101 is higher than the connecting portion 103 and the first end 381 of the side wall 308 of the housing 102. When the button assembly 100 is installed, the pressing portion 101 is aligned with the installation hole 724 of the installation panel 720, such that the pressing portion 101 passes through the installation hole 724. When the button assembly 100 is installed in place in the installation panel 720, the pressing surface of the pressing portion 101 is roughly flush with the first side 721 of the installation panel 720, and the annular rib 590 of the connecting portion 103 abuts against the second side of the installation panel 720 and is pressed to undergo a certain deformation. The first side 721 is arranged facing the user, and the operator can operate the pressing surface 403. The annular rib 590 is pressed to deform so as to form a seal with the second side of the installation panel 720, and the annular rib 590 can prevent a further flow of water in the gap between the pressing portion 101 and the installation panel 720, thus preventing the water from entering a corresponding structure located on the second side of the installation panel 720.

In an aspect of the present disclosure, at an initial position of the pressing portion 101, there is a spacing between the trigger protrusion 405 of the pressing portion 101 and the trigger portion 602 of the circuit device 160. When the operator applies a pressure to the pressing surface 403 of the pressing portion 101, the pressure overcomes an elastic force of the connecting portion 103, so that the pressing portion 101 moves toward the circuit device 160; and when the trigger protrusion 405 of the pressing portion 101 comes into contact with the trigger portion 602 of the circuit device 160, the pressing portion 101 reaches a trigger position, and the corresponding circuit is triggered. When the operator removes the pressure applied to the pressing portion 101, the elastic force of the connecting portion 103 causes the pressing portion 101 to move away from the circuit device 160 and to return to the initial position. The spacing between the pressing portion 101 and the circuit device 160 is set such that the pressing portion 101 can trigger the circuit device 160 when the pressing portion 101 is subjected to an external force, and the spacing between the pressing portion 101 and the circuit device 160 is kept when the external force is removed, so that false triggering is less likely to occur.

In another aspect of the present disclosure, at the initial position of the pressing portion 101, the trigger protrusion 405 of the pressing portion 101 contacts an elastic component of the trigger portion 602 of the circuit device 160. When the operator applies a pressure to the pressing surface 403 of the pressing portion 101, the pressure overcomes an elastic force of the connecting portion 103 and an elastic force of the elastic component of the trigger portion 602, so that the pressing portion 101 moves toward the circuit device 160 by a certain distance, and the elastic component of the trigger portion 602 is deformed and reaches a specific position, the pressing portion 101 reaches a trigger position, and the corresponding circuit is triggered. When the operator removes the pressure applied to the pressing portion 101, the elastic force of the connecting portion 103 and the elastic force of the clastic component of the trigger portion 602 jointly cause the pressing portion 101 to move away from the circuit device 160 and to return to the initial position.

In the present disclosure, the body 150 of the button assembly 100 is of an integrated structure, and the gap between the pressing portion 101 and the housing 102 is sealed by the connecting portion 103, so that the button assembly has a good waterproof function, and the water in the vicinity of the pressing portion 101 can be prevented from entering the interior of the button assembly 100. The circuit device 160 is sealed inside the housing 102 by means of the potting process, so that the water from the second opening 316 can be prevented from affecting the performance of the circuit device 160.

In the present disclosure, the circuit device 160 is directly installed into the housing 102, so that the circuit device 160 is connected to the housing without additionally providing a fastening structure. The button assembly of the present disclosure has fewer parts, thus decreasing installation steps of the button assembly 100.

Although the present disclosure is described with reference to the examples of aspects outlined above, various alternatives, modifications, variations, improvements and/or substantial equivalents, which are known or anticipated at present or to be anticipated before long, may be obvious to those of at least ordinary skill in the art. In addition, the technical effects and/or technical problems described in this specification are exemplary rather than limiting; therefore, the disclosure in this specification may be used to solve other technical problems and may have other technical effects. Accordingly, the examples of the aspects of the present disclosure as set forth above are intended to be illustrative rather than limiting. Various changes may be made without departing from the spirit or scope of the present disclosure. Therefore, the present disclosure is intended to embrace all known or earlier disclosed alternatives, modifications, variations, improvements and/or substantial equivalents.

What is claimed is:

1. A button assembly, comprising:
a pressing portion;
a housing, the housing comprising a tubular side wall, the side wall having a first end and a second end, and the first end having a first opening; and
a connecting portion arranged between the pressing portion and the housing, the connecting portion being connected to the pressing portion and the first end of the side wall in a sealed manner, such that the pressing portion and the connecting portion cover the first opening;
wherein the connecting portion is made of an elastic material, such that the pressing portion is movable relative to the housing.

2. The button assembly of claim 1, wherein
the pressing portion, the connecting portion, and the housing are of an integrated structure.

3. The button assembly of claim 1, wherein
the button assembly further comprises a circuit device located inside the housing.

4. The button assembly of claim 3, wherein
an inner side of the housing comprises a limiting surface and a snap, the limiting surface being arranged facing the second end, the snap being located at a side of the limiting surface facing the second end, and the circuit device being capable of being clamped between the limiting surface and the snap.

5. The button assembly of claim 4, wherein
the limiting surface continuously extends in a circumferential direction.

6. The button assembly of claim 5, wherein
when the circuit device is installed in the housing, the circuit device is sealed within the housing by means of a potting and sealing process.

7. The button assembly of claim 1, wherein
both the pressing portion and the first end of the housing have an anti-off structure, the anti-off structure comprising protrusions, grooves and/or stepped portions.

8. The button assembly of claim 1, wherein
the connecting portion comprises an annular rib, the rib protruding from an outer surface of the connecting portion toward a direction away from the second end of the side wall.

9. The button assembly of claim 1, wherein
the connecting portion is connected to the pressing portion and the housing by means of a two-color injection molding process.

10. The button assembly of claim 3, wherein
an inner wall of the housing comprises a guide rib extending in a direction from the second end to the first end of the side wall, the circuit device comprises a guide recess, and the guide recess is capable of cooperating with the guide rib to guide an installation direction of the circuit device.

11. The button assembly of claim 6, wherein
the second end has a second opening, when the circuit device is connected to the housing, the circuit device is installed into the housing from the second opening, causing the circuit device to be clamped between the limiting surface and the snap, and then the circuit device is potted through the second opening, such that the circuit device is connected to the housing in a sealed manner.

12. The button assembly of claim 1, wherein
the connecting portion comprises a corrugated portion.
